(19) United States
(12) Patent Application Publication
(10) Pub. No.: US 2026/0177528 A1
(43) Pub. Date: Jun. 25, 2026

(54) GAS SENSING DEVICE, OPERATING METHOD OF GAS SENSING DEVICE, AND GAS SENSING MATERIAL

(71) Applicants: SAMSUNG ELECTRONICS CO., LTD., Suwon-si (KR); IUCF-HYU (INDUSTRY-UNIVERSITY COOPERATION FOUNDATION HANYANG UNIVERSITY), Seoul (KR)

(72) Inventors: Kwangwook CHOI, Suwon-si (KR); Seonjin CHOI, Seoul (KR); Yeonjoo KIM, Seoul (KR); Ihwan KIM, Suwon-si (KR); Jaewoo SEO, Seoul (KR); Donghee LEE, Seoul (KR); Seokwhan CHUNG, Suwon-si (KR); Youseok KANG, Seoul (KR); Jeonggil SEO, Seoul (KR)

(73) Assignees: SAMSUNG ELECTRONICS CO., LTD., Suwon-si (KR); IUCF-HYU (INDUSTRY-UNIVERSITY COOPERATION FOUNDATION HANYANG UNIVERSITY), Seoul (KR)

(21) Appl. No.: 19/429,410

(22) Filed: Dec. 22, 2025

(30) Foreign Application Priority Data
Dec. 24, 2024 (KR) 10-2024-0196071

(51) Int. Cl. G01N 29/036; G01N 29/02; G01N 29/24

(52) U.S. Cl. CPC G01N 29/036; G01N 29/022; G01N 29/2437; G01N 2291/014; G01N 2291/021

(57) ABSTRACT

Provided are a gas sensing device, an operating method of a gas sensing device, and a gas-sensing material. The gas sensing device includes: a first sensing element having a resonant frequency that varies based on adsorbed gas; an oscillation circuit configured to apply a driving voltage to the first sensing element; a counter circuit configured to measure a resonant frequency output from the first sensing element; and a controller configured to determine a weight of the adsorbed gas, wherein the first sensing element includes: a resonator; and a gas-sensing layer including a gas-sensing material, wherein the gas-sensing material includes: a support including a three-dimensional metal-organic framework; and a dual hydrogen bond donor-based receptor bound to the support, and wherein the three-dimensional metal-organic framework includes: a plurality of metal cation nodes; and an organic ligand between adjacent metal cation nodes of the plurality of metal cation nodes.

### CROSS-REFERENCE TO RELATED APPLICATION

This application is based on and claims priority under 35 U.S.C. § 119 to Korean Patent Application No. 10-2024-0196071, filed on Dec. 24, 2024, in the Korean Intellectual Property Office, the disclosure of which is incorporated by reference herein in its entirety.

### BACKGROUND

### 1. Field

The present disclosure relates to a gas sensing device, an operating method of a gas sensing device, and a gas sensing material.

### 2. Description of Related Art

Various harmful gases may be present in the atmosphere. A gas sensing layer may be used to detect harmful gases present in the atmosphere in real time. A gas sensing device including a gas sensing layer may be installed in a space where harmful gases may be generated. A gas sensing device may be installed in a portable device to detect harmful gases in the atmosphere in various locations. The gas sensing layer may include, for example, polymers, inorganic materials, and the like. The polymers, inorganic materials, and the like included in the gas sensing layer may be selected according to the type of harmful gas. A gas sensing device including a gas sensing layer capable of effectively detecting harmful gases is needed.

In a semiconductor clean room, a semiconductor process is performed, and a strong alkaline gas, such as ammonia gas, may be generated or introduced during the semiconductor process. Alkaline gas may corrode metal wiring and thin films on a wafer manufactured in the semiconductor process. Alkaline gas may cause defects in semiconductor devices on a wafer. Ammonia gas may, for example, be adsorbed on a wafer surface to form an ionic ammonium component. The ionic ammonium component may cause a malfunction of the semiconductor device through charge formation. In a semiconductor clean room, a gas sensing device that measures gas components and concentrations in real time is required in a wafer container (FOUP: Front Opening Unified Pod) in which various harmful gases are concentrated. In addition, a gas sensing device that may be used for measuring environmental gases such as NOx, SOx, and CO in the atmosphere, indoor air, and freshness in a refrigerator is required.

### SUMMARY

Provided is a gas sensing device that provides improved sensing performance for alkaline gases.

Provided is a method of operating the gas sensing device.

Provided is a novel gas sensing material used in the gas sensing device is also provided.

Additional aspects will be set forth in part in the description which follows and, in part, will be apparent from the description, or may be learned by practice of the presented embodiments of the disclosure.

According to an aspect of the disclosure, a gas sensing device includes: a first sensing element having a resonant frequency that varies based on adsorbed gas; an oscillation circuit configured to apply a driving voltage to the first sensing element; a counter circuit configured to measure a resonant frequency output from the first sensing element; and a controller configured to determine a weight of the adsorbed gas, wherein the first sensing element includes: a resonator; and a gas-sensing layer including a gas-sensing material, wherein the gas-sensing material includes: a support including a three-dimensional metal-organic framework; and a dual hydrogen bond donor-based receptor bound to the support, and wherein the three-dimensional metal-organic framework includes: a plurality of metal cation nodes; and an organic ligand between adjacent metal cation nodes of the plurality of metal cation nodes.

The organic ligand includes a single phenylene group between the adjacent metal cation nodes.

The dual hydrogen bond donor-based receptor may be represented by Formula 1:

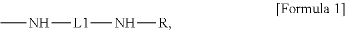

and
wherein —NH-L1-NH— is a dual hydrogen bond donor moiety, L1 is a thiocarbonyl group or a cycloalkenone group, and R is an aromatic group having 6 to 20 carbon atoms, substituted with an electron-withdrawing group.

The dual hydrogen bond donor-based receptor may be represented by Formula 2:

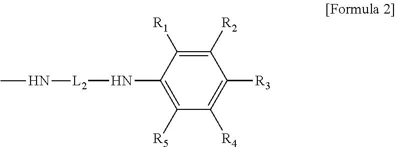

wherein L₂ is a thiocarbonyl group, a cyclobutenedione group, or a cyclopentenetrione group, R₁, R₂, R₃, R₄, and R₅ are each independently a halogen, a halogen-substituted or unsubstituted C1 to C10 alkyl group, a halogen-substituted or unsubstituted C2 to C10 alkenyl group, and a halogen-substituted or unsubstituted C6 to C20 aryl group, and at least one of R₁, R₂, R₃, R₄, and R₅ may include a halogen.

The resonator may include a thin-film bulk acoustic resonator (FBAR), a surface acoustic wave (SAW) resonator, a bulk acoustic wave (BAW) resonator, a solid mounted resonator (SMR), a quartz crystal microbalance (QCM) resonator, or a combination thereof.

The first sensing element may be a thin-film bulk acoustic resonator (FBAR) element, and the FBAR element may include: a substrate; a first electrode on the substrate; a second electrode on the first electrode; a piezoelectric layer between the first electrode and the second electrode; a gas-sensing layer on the second electrode; and a micro-heater adjacent to the gas-sensing layer.

The first sensing element may be a surface acoustic wave (SAW) resonator element, and the SAW resonator element may include: a piezoelectric substrate; a first electrode on an upper surface of the piezoelectric substrate; a second electrode on the upper surface of the piezoelectric substrate; a gas-sensing layer between the first electrode and the second electrode; and a micro-heater on the piezoelectric substrate and adjacent to the gas-sensing layer.

The first electrode may be a first interdigital transducer (IDT) electrode configured to generate surface acoustic waves, the second electrode may be a second IDT electrode configured to receive the surface acoustic waves that have passed through the gas-sensing layer, and the gas sensing device may further include a protective layer on the first IDT electrode and the second IDT electrode.

The micro-heater may include at least one micro-heater electrode, the at least one micro-heater electrode is adjacent to one side of the gas-sensing layer, and extends from a region adjacent to the first electrode to a region adjacent to the second electrode, and the at least one micro-heater electrode may include a plurality of zigzag patterns.

The gas-sensing layer may be free of polymer.

The gas sensing device may further include: an inlet configured to receive supply of the gas; and at least one flow path configured to guide the gas from the inlet to the first sensing element, the at least one flow path may include a first flow path provided with at least one of a temperature sensor and a humidity sensor, and the controller may be further configured to perform calibration for a change in the resonant frequency caused by at least one of temperature and humidity.

The at least one flow path may further include a second flow path provided with a dehumidifying filter, a deodorizing filter, or a combination thereof, or a third flow path configured to guide the gas from the inlet to the first sensing element without filtration.

The gas sensing device may further include a second sensing element free of the gas-sensing layer.

The oscillation circuit may include an amplifier, and the first sensing element and the amplifier may form a feedback loop having a gain of or more.

According to an aspect of the disclosure, an operating method of a gas sensing device, includes: applying, from an oscillation circuit, a driving voltage to a first sensing element including a gas-sensing layer; inputting, into a counter circuit, a resonant frequency output from the first sensing element; and determining, by a controller, a weight of adsorbed gas from a change in the resonant frequency corresponding to gas adsorbed to the gas-sensing layer of the first sensing element, wherein the gas-sensing layer includes a gas-sensing material, and the gas-sensing material includes: a support including a three-dimensional metal-organic framework; and a dual hydrogen bond donor-based receptor bound to the support, and the three-dimensional metal-organic framework includes: a plurality of metal cation nodes; and an organic ligand between adjacent metal cation nodes of the plurality of metal cation nodes.

The dual hydrogen bond donor-based receptor is represented by Formula 1:
[Formula 1]
—NH-L1-NH—R, where —NH-L1-NH— is a dual hydrogen bond donor moiety, L1 is a thiocarbonyl group or a cycloalkenone group, and R is an aromatic group having 6 to 20 carbon atoms, substituted with an electron-withdrawing group.

The operating method may further include regenerating the gas-sensing layer by heating the first sensing element.

According to an aspect of the disclosure, a gas-sensing material includes: a support including a three-dimensional metal-organic framework; and a dual hydrogen bond donor-based receptor bound to the support, wherein the three-dimensional metal-organic framework includes: a plurality of metal cation nodes; and an organic ligand between adjacent metal cation nodes of the plurality of metal cation nodes, wherein the dual hydrogen bond donor-based receptor is represented by Formula 1:

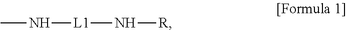

and
wherein —NH-L1-NH— is a dual hydrogen bond donor moiety, L1 is a thiocarbonyl group or a cycloalkenone group, and R is an aromatic group having 6 to 20 carbon atoms, substituted with an electron-withdrawing group.

The dual hydrogen bond donor-based receptor may be represented by Formula 2:

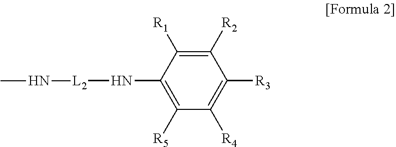

wherein L₂ is a thiocarbonyl group, a cyclobutenedione group, or a cyclopentenetrione group, R₁, R₂, R₃, R₄, and R₅ are each independently a halogen, a halogen-substituted or unsubstituted C1 to C10 alkyl group, a halogen-substituted or unsubstituted C2 to C10 alkenyl group, and a halogen-substituted or unsubstituted C6 to C20 aryl group, and at least one of R₁, R₂, R₃, R₄, or R₅ may include a halogen.

The dual hydrogen bond donor-based receptor may be represented by one of Formulas 3A, 3B, and 3C:

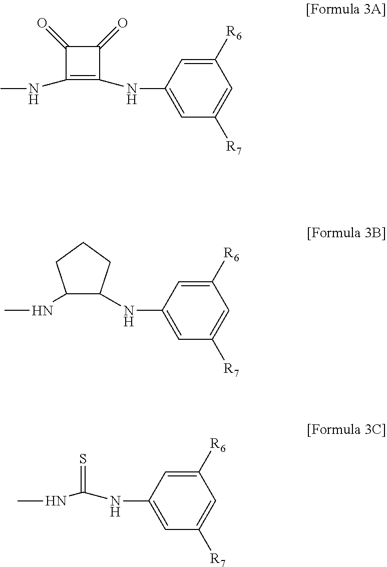

wherein R₆ and R₇ are each independently a halogen, a halogen-substituted or unsubstituted C1 to C5 alkyl group, a halogen-substituted or unsubstituted C2 to C5 alkenyl group, and a halogen-substituted or unsubstituted C6 to C20 aryl group, and at least one of R₆ and R₇ may include a halogen.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a schematic diagram of a gas sensing device according to an embodiment;

FIG. 2 is a schematic diagram showing a portion of a gas sensing device according to an embodiment;

FIG. 3 is a schematic cross-sectional view of a thin-film bulk acoustic resonator (FBAR) element according to an embodiment;

FIG. 4 is a schematic plan view of a surface acoustic wave (SAW) resonator element according to another embodiment;

FIG. 5 is a schematic cross-sectional view of a surface acoustic wave (SAW) resonator element according to another embodiment;

FIG. 6 is a schematic diagram of an interdigital transducer (IDT) electrode according to an embodiment;

FIG. 7 is a schematic diagram of a micro-heater according to an embodiment;

FIG. 8 is a schematic diagram of a gas sensing device according to an embodiment;

FIG. 9 is a schematic diagram of a gas sensing device according to an embodiment;

FIG. 10 is a schematic diagram of a gas sensing device including an amplifier according to an embodiment;

FIG. 11 is a feedback loop circuit diagram of a gas sensing device according to an embodiment;

FIG. 12 is an illustration of a gas sensing material according to an embodiment;

FIG. 13 is an illustration of a metal-organic framework (UIO-66-NH₂) containing amine groups;

FIG. 14 is a scanning electron microscope (SEM) image of a metal-organic framework (UiO-66-NH₂) containing amine groups;

FIG. 15 is an illustration of a metal-organic framework (UiO-66-SQ) containing a dual hydrogen bond donor-based receptor;

FIG. 16 is a scanning electron microscope (SEM) image of a metal-organic framework (UiO-66-SQ) containing a dual hydrogen bond donor-based receptor;

FIG. 17 is an XRD spectrum of a gas sensing material (UiO-66-NH₂) of Comparative Example 1 and a gas sensing material (UiO-66-SQ) of Example 1;

FIG. 18 is an infrared spectrum of a gas sensing material (UIO-66-NH₂) of Comparative Example 1 and a gas sensing material (UiO-66-SQ) of Example 1;

FIG. 19 is a graph of an ammonia temperature programmed desorption (TPD) analysis of a gas sensing material (UiO-66-NH₂) of Comparative Example 1;

FIG. 20 is a graph of an ammonia temperature programmed desorption (TPD) analysis of a gas sensing material (UiO-66-SQ) of Example 1;

FIG. 21A is an image of a thin-film bulk acoustic resonator in which a gas sensing layer including a gas sensing material prepared in Example 1 is introduced onto a top electrode;

FIG. 21B is a scanning electron microscope image of a surface of a gas sensing layer formed by coating 4 ng of a gas sensing material prepared in Example 1 onto a top electrode;

FIG. 21C is a scanning electron microscope image of a surface of a gas sensing layer formed by coating 0.4 ng of a gas sensing material prepared in Example 1 onto a top electrode;

FIG. 21D is a scanning electron microscope image of a surface of a gas sensing layer formed by coating 0.04 ng of a gas sensing material prepared in Example 1 onto a top electrode;

FIG. 22 is an image of a SAW resonator element according to an embodiment; and

FIG. 23 is a schematic diagram of a SAW resonator element according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Various embodiments are illustrated in the accompanying drawings. However, the present disclosure may be embodied in many different forms and should not be construed as limited to the embodiments set forth herein. Rather, these embodiments are provided so that this disclosure will be thorough and complete, and will fully convey the scope of the disclosure to those skilled in the art.

Exemplary embodiments are described herein with reference to cross-sectional illustrations that are schematic illustrations of idealized embodiments. As a result, for example, of manufacturing techniques and/or tolerances, variations from the shapes of the illustrations are to be expected. Therefore, the embodiments described in this disclosure should not be construed as limited to the particular shapes of regions as illustrated in the drawings herein but are to include deviations in shapes that result, for example, from manufacturing. For example, regions illustrated or described as flat may typically have rough and/or nonlinear features. Further, angles illustrated as being sharp may be rounded. Therefore, the regions illustrated in the figures are schematic in nature and their shapes are not intended to illustrate the precise shape of a region and are not intended to limit the scope of the claims. In this disclosure, the same reference numerals refer to the same elements.

Terms such as “first,” “second,” “third,” etc., may be used herein to describe various elements, components, regions, layers and/or sections, but these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

Spatially relative terms, such as “beneath,” “below,” “lower,” “above,” “upper,” “top” and the like, may be used herein for ease of description to describe one element or feature's relationship to another element(s) or feature(s). It will be understood that spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly. It will be understood that when an element is referred to as being “on” another element, it can be directly on the other element or intervening elements may be present therebetween. In contrast, when an element is referred to as being “directly on” another element, there are no intervening elements present.

The singular forms used in this disclosure include the plural forms including “at least one,” unless the context clearly dictates otherwise. “At least one” should not be construed as limiting to the singular. As used herein, the term “and/or” includes any and all combinations of one or more of the associated listed items. The terms “comprises” and/or “comprising,” as used herein, specify the presence of stated features, integers, steps, operations, elements, and/or components, but do not preclude the presence or addition of one or more other features, integers, steps, operations, elements, components, and/or groups thereof.

Unless otherwise defined, all terms used in the present specification (including technical and scientific terms) have the same meaning as commonly understood by one of ordinary skill in the art to which this disclosure belongs. It should also be understood that terms such as those defined in commonly used dictionaries should be interpreted as having meanings consistent with their meaning in the context of the relevant art and the present disclosure, and should not be interpreted in an idealized or overly formal sense.

While specific embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications, variations, improvements, and substantial equivalents.

Hereinafter, a gas sensing device, a method of operating a gas sensing device, and a gas sensing material according to embodiments will be described in greater detail.

### [Gas Sensing Device]

A gas sensing device according to an embodiment includes: a first sensing element having a resonant frequency that varies in response to adsorbed gas; an oscillation circuit configured to apply a driving voltage to the first sensing element; a counter circuit configured to measure a resonant frequency output from the first sensing element; and a controller configured to calculate a weight of the adsorbed gas. The first sensing element includes a resonator and a gas sensing layer including a gas sensing material. The gas sensing material includes a support including a three-dimensional metal-organic framework; and a dual hydrogen bond donor-based receptor bound to the support. The three-dimensional metal-organic framework includes a plurality of metal cation nodes and an organic ligand between adjacent metal cation nodes of the plurality of metal cation nodes.

By including the three-dimensional metal-organic framework, the gas sensing material may be easily placed on the resonator. Furthermore, because the gas sensing material includes the three-dimensional metal-organic framework, the gas sensing material may be fixed onto the resonator without a separate binder such as a polymer.

The metal-organic framework includes an organic ligand disposed between adjacent metal cation nodes among the plurality of metal cation nodes, and by including, for example, a single phenylene group in the organic ligand between adjacent metal cation nodes, the metal-organic framework may have a compact size. Because the metal-organic framework is compact in size, the amount of gas sensing material that can be placed per unit area of the resonator may be increased. As a result, the sensing performance of the gas sensing device may be improved. In contrast, a metal-organic framework having organic ligands having, for example, a plurality of phenylene groups between adjacent metal cation nodes, may have an increased volume. Because the metal-organic framework has an increased size, the amount of gas sensing material that can be placed per unit area of the resonator may decrease. As a result, the sensing performance of the gas sensing device may be reduced.

By including a dual hydrogen bond donor-based receptor, the gas sensing material can readily form hydrogen bonds with alkaline gases, such as ammonia gas, allowing alkaline gases to be easily adsorbed onto the gas sensing material.

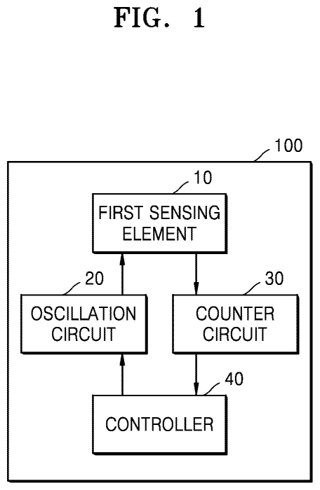

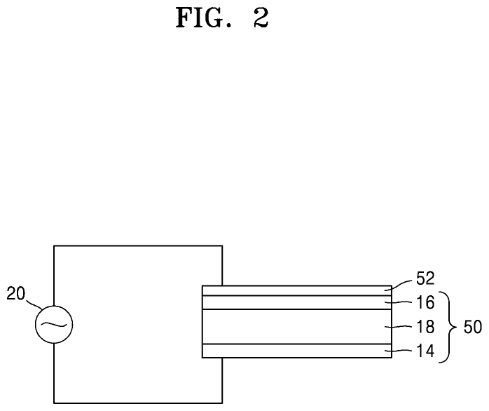

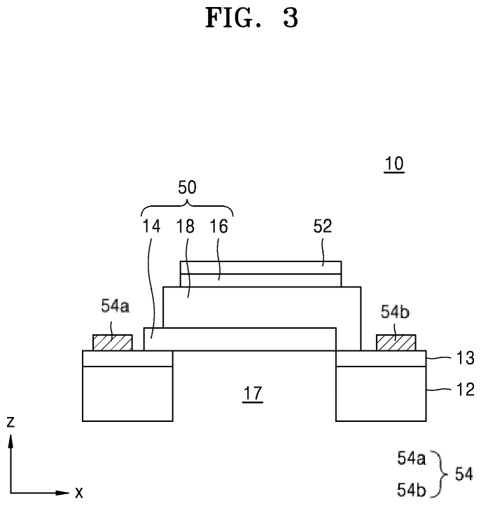

FIG. 1 is a schematic diagram of a gas sensing device according to an embodiment. FIG. 2 is a schematic diagram showing a portion of a gas sensing device according to an embodiment. FIG. 3 is a schematic cross-sectional view of a thin film bulk acoustic resonator (FBAR) element according to an embodiment.

Referring to FIG. 1, a gas sensing device 100 may include: a first sensing element 10 having a resonant frequency that varies in response to adsorbed gas; an oscillation circuit 20 configured to apply a driving voltage to the first sensing element 10; a counter circuit 30 configured to measure a resonant frequency output from the first sensing element 10; and a controller 40 configured to calculate the weight of adsorbed gas. The first sensing element 10 may have a resonant frequency, and the weight of the first sensing element 10 may change as gas is adsorbed on the first sensing element 10. The resonant frequency of the first sensing element 10 may change in response to the change of the weight of the first sensing element 10. The oscillation circuit 20 may apply a driving voltage to the first sensing element 10.

Referring to FIG. 2, the oscillation circuit 20 may apply, for example, a driving voltage having a constant frequency, to the first sensing element, which may include a resonator 50; a gas sensing layer 52 including a gas sensing material; and a heater, wherein the resonator 50 may include a first electrode 14, a second electrode 16, and a piezoelectric layer 18 between the first electrode 14 and the second electrode 16. The oscillation circuit 20 may include a voltage source, and the voltage source may be electrically connected to the first sensing element 10 through an electrical path. When a voltage is applied at a resonant frequency, the first sensing element 10 may resonate in a thickness direction (Z direction). The counter circuit 30 may measure the resonant frequency of the first sensing element 10. The counter circuit 30 may receive a signal output from the first sensing element 10 and measure the resonant frequency. The controller 40 may calculate the weight of the gas adsorbed onto the first sensing element 10 based on changes in the resonant frequency measured by the counter circuit 30.

Referring to FIG. 3, a first sensing element 10 may include a resonator 50; a gas sensing layer 52 including a gas sensing material; and a heater. The resonator 50 may include a first electrode 14, a second electrode 16, and a piezoelectric layer 18 between the first electrode 14 and the second electrode 16. The resonant frequency Fₒ of the resonator 50 may be determined, for example, by an acoustic wave velocity V of the piezoelectric layer 18 and a thickness d of the piezoelectric layer 18. For example, the resonant frequency Fₒ may be represented by F0≈V/2d. The gas sensing layer 52 may include a gas sensing material, and gas may be adsorbed onto the gas sensing layer 52. The weight of the gas sensing layer 52 changes as gas is adsorbed on the gas sensing layer 52. The resonant frequency of the resonator 50 connected to the gas sensing layer 52 may change in response to changes in the weight of the gas sensing layer 52. A heater may heat the resonator 50, thereby removing the gas adsorbed onto the gas sensing layer 52 and regenerating the first sensing element 10. By periodically heating the resonator 50 with the heater, the lifespan of the first gas sensor may be extended.

Referring to FIG. 1, the resonator 50 may include a film bulk acoustic resonator (FBAR), a surface acoustic wave (SAW) resonator, a bulk acoustic wave (BAW) resonator, a solid mounted resonator (SMR), a quartz crystal microbalance (QCM) resonator, or a combination thereof.

Referring to FIG. 3, the first sensing element 10 may be a FBAR element. The FBAR element may include a substrate 12, the first electrode 14 on the substrate 12, the second electrode 16 on the first electrode 14, the piezoelectric layer 18 between the first electrode 14 and the second electrode 16, the gas sensing layer 52 on the second electrode 16, and micro-heaters 54, 54a, 54b positioned adjacent to or around the gas sensing layer 52. The FBAR element may be arranged on a surface of the substrate 12, which may be silicone. An insulating layer 13, such as silica, may be disposed on the surface of the substrate 12. The piezoelectric layer 18 may be made of zinc oxide (ZnO), aluminum nitride (AlN), lead zirconate titanate (PZT), or the like. The first electrode 14 and the second electrode 16 may each be a conductive metal layer. The first electrode 14, the piezoelectric layer 18, and the second electrode 16 may form a stack. The thickness of the stack may be, for example, 10 μm or less, 5 μm or less, or 2 μm or less. A portion of the back side of the stack or a portion of the substrate 12 may be removed through bulk silicon etching to form an opening 17. The resulting structure may be a stack that includes the first electrode 14, the piezoelectric layer 18, and the second electrode 16, positioned above the opening 17 of the substrate 12. The FBAR element may include a membrane element positioned above the opening 17 of the substrate 12. The gas sensing layer 52 may be positioned on the second electrode 16. By including the aforementioned gas sensing material, the gas sensing layer 52 may be able to adsorb gas. The micro-heaters 54, 54a, 54b may be positioned adjacent to or around the gas sensing layer 52. As the gas sensing layer 52 is heated, the gas adsorbed on the gas sensing layer 52 is removed, thereby regenerating the gas sensing layer 52.

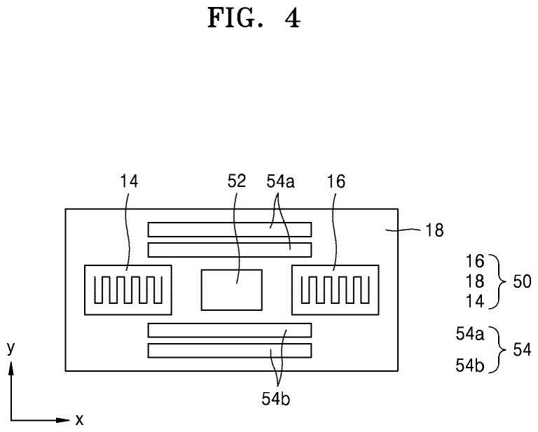

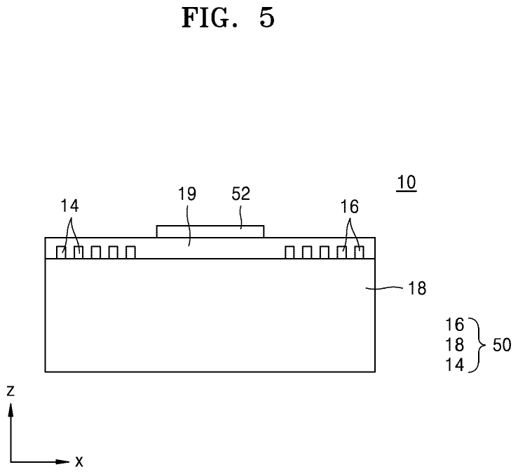

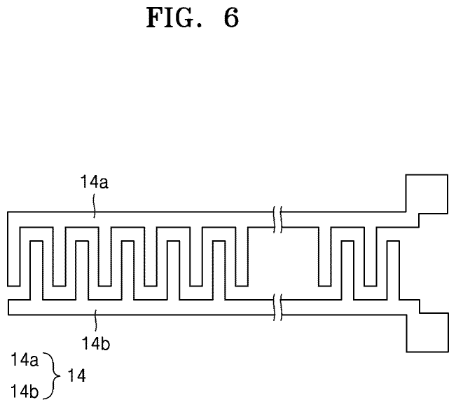

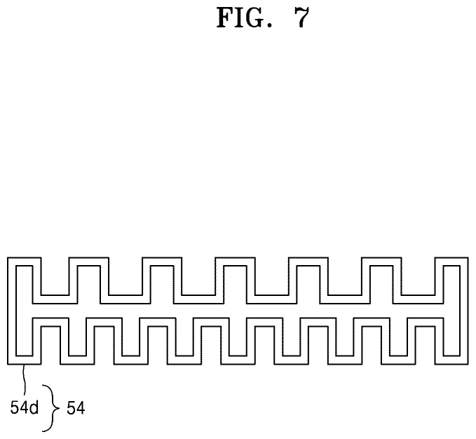

FIG. 4 is a schematic plan view of a surface acoustic wave (SAW) resonator element according to another embodiment. FIG. 5 is a schematic cross-sectional view of a SAW element according to another embodiment. FIG. 6 is a schematic diagram of an interdigital transducer (IDT) electrode according to an embodiment. FIG. 7 is a schematic diagram of a micro-heater according to an embodiment.

Referring to FIGS. 4 and 5, a first sensing element 10 may be a surface acoustic wave (SAW) resonator element. The SAW element may include a piezoelectric substrate 18, a first electrode 14 and a second electrode 16 positioned on an upper surface of the piezoelectric substrate 18, a gas sensing layer 52 positioned between the first electrode 14 and the second electrode 16, and micro-heaters 54, 54a, 54b arranged adjacent to the gas sensing layer 52 on the piezoelectric substrate 18. The piezoelectric substrate 18 may be a substrate made of a piezoelectric material. The piezoelectric material is a material whose electrical properties change in response to a mechanical signal, or which exhibits a mechanical effect in response to an electrical signal. The piezoelectric substrate 18 may include, for example, lithium niobate (LiNbO₃), lithium tantalate (LiTaO₃), lithium tetraborate (Li₂B₄O₇), barium titanate (BaTiO₃), lead zirconate (PbZrO₃), lead titanate (PbTiO₃), lead zirconate titanate (PZT), zinc oxide (ZnO), gallium arsenide (GaAs), quartz, niobate, berlinite, topaz, tourmaline group materials, potassium niobate, sodium tungstate, Ba₂NaNb₅O₅, and Pb₂KNb₅O₁₅. The first electrode 14 may convert an electrical signal input from an oscillation element into a surface acoustic wave (SAW), which is a mechanical signal. The first electrode 14 may generate a SAW that propagates in the direction of the gas sensing layer 52 (X direction). Referring to FIG. 6, the first electrode 14 may be, for example, a first interdigital transducer (IDT) electrode 14, 14a, 14b that generates a SAW. The first interdigital electrode 14, 14a, 14b may have, for example, a shape in which a pair of comb-shaped first electrodes are alternately arranged along one direction (X direction). The SAW may pass through the gas sensing layer 52 and be transmitted to the second electrode 16. The second electrode 16 may convert the SAW, which is a mechanical signal propagating from the direction of the gas sensing layer 52 (X direction), into an electrical signal. The second electrode 16 may output the electrical signal to the counter circuit 30. The second electrode 16 may be, for example, a second IDT electrode configured to receive the SAW having passed through the gas sensing layer 52.

Referring to FIG. 6, the second interdigital transducer electrode may have substantially the same structure as the first IDT electrode 14, 14a, 14b, and may be arranged on the piezoelectric substrate 18 so as to be symmetrical to the first IDT electrode 14, 14a, 14b, with the gas sensing layer 52 therebetween. As the SAW passes through the gas sensing layer 52, the SAW interferes with the gas sensing layer 52, and the frequency, phase, intensity, clock count, etc., of the electrical signal output from the second electrode 16 may be changed. For example, in response to increases of the weight of the gas sensing layer 52, the frequency, phase, intensity, clock count, etc., of the signal output from the second electrode 16 may be changed.

Referring to FIG. 5, the first gas sensing element may further include a protective layer 19 positioned on a surface of at least one of the first IDT electrode or the second IDT electrode. As at least one of the first IDT electrode or the second IDT electrode is covered with the protective layer 19, deterioration, such as corrosion of the electrode surface due to, for example, long-term exposure to the sample gas, may be prevented. The lifespan of the gas sensing device 100 may be improved. The protective layer 19 may be of any material that, for example, transmits surface acoustic waves and can block contact between the electrode and the sample gas. The protective layer 19 may be, for example, a polymer layer. The gas sensing layer 52 may be positioned, for example, on the protective layer 19. As the gas sensing layer 52 is positioned on the protective layer 19, the protective layer 19 may be easily positioned on the first IDT electrode and the second IDT electrode. Alternatively, although not shown in the drawings, the protective layer 19 may be positioned on the first IDT electrode and the second IDT electrode, but not between the first IDT electrode and the second IDT electrode. By not placing the protective layer 19 between the first IDT electrode and the second IDT electrode, the influence of the protective layer 19 on the surface acoustic wave may be reduced.

Referring to FIG. 4, the first gas sensing element may further include a heater. By including a heater in the first sensing element, deterioration of the first sensing element may be prevented through periodic heating. The lifespan of the gas sensing device 100 may be improved.

Referring to FIG. 4, the micro-heaters 54, 54a, 54b may include, for example, one or more electrodes of the micro-heater 54, 54a, 54b. As the micro-heaters 54, 54a, 54b include a plurality of micro-electrodes spaced apart on the surface of the piezoelectric substrate 18, the surface of the piezoelectric substrate 18 may be uniformly heated. The electrodes of the micro-heater 54, 54a, 54b may extend adjacent to one side of the gas sensing layer 52, for example, from a region adjacent to the first electrode 14 to a region adjacent to the second electrode 16. As the electrodes of the micro-heater 54, 54a, 54b extend from a region adjacent to the first electrode 14 to a region adjacent to the second electrode 16, the first electrode 14, the second electrode 16, and the gas sensing layer 52 may be heated simultaneously.

Referring to FIG. 7, the electrodes of the micro-heater 54, 54d may include, for example, a plurality of zigzag patterns. With electrodes of the micro-heater 54, 54d including a plurality of zigzag patterns, it may be possible to maintain the surface area of the first sensing element 10 while increasing heat generation per unit area.

Although not shown in the drawings, the micro-heater 54, 54a, 54b electrodes may have a loop shape that surrounds the gas sensing layer 52. By having this loop shape on the surface of the piezoelectric substrate 18 and surrounding the gas sensing layer 52, the micro-heater 54, 54a, 54b electrode may intensively heat the gas sensing layer 52, thereby improving heating efficiency.

Referring to FIGS. 3 to 5, the gas sensing layer 52 may be free of a polymer. The gas sensing layer 52 may not include a polymer. The gas sensing material may be coated onto the resonator 50 in a solution form, and after removing the solvent, the gas sensing layer 52 may be formed on the resonator 50 through physical forces such as van der Waals interactions. Because the gas sensing material has a small particle size, the gas sensing material may be bound to the electrode of the resonator 50 by van der Waals interactions alone. Because the gas sensing layer 52 does not include an additional binder, such as a polymer binder, the effective contact area between the gas and the gas sensing material may be increased, thereby enhancing the gas sensing efficiency of the gas sensing layer 52. Moreover, because the gas sensing layer 52 does not include other additives in addition to the gas sensing material, any measurement errors caused by other additives may be reduced.

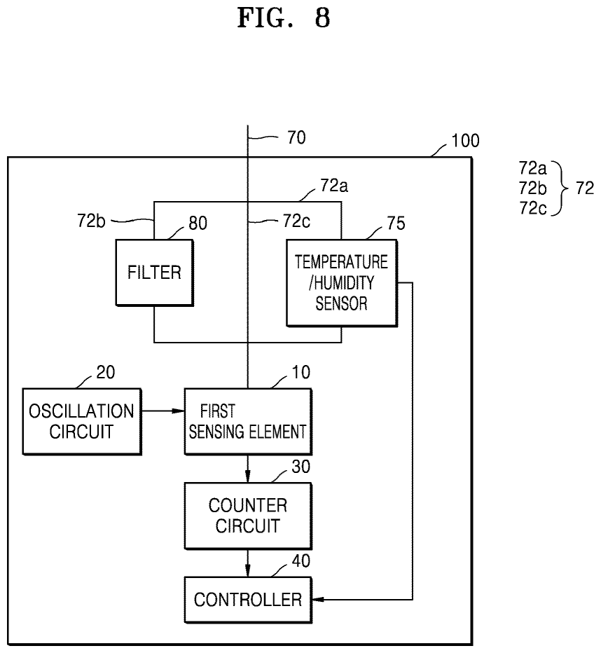

FIG. 8 is a schematic diagram of a gas sensing device according to an embodiment.

Referring to FIG. 8, a gas sensing device 100 may include a first sensing element 10 having a resonant frequency that varies in response to adsorbed gas; an oscillation circuit 20 configured to apply a driving voltage to the first sensing element 10; a counter circuit 30 configured to measure a resonant frequency output from the first sensing element 10; and a controller 40 configured to calculate the weight of the adsorbed gas. Gas, such as external air, may be supplied through an inlet 70. The inlet 70 may supply gas at a constant flow rate through a fan or pump. Supplying the gas at a constant flow rate may remove noise factors such as pressure fluctuations caused by flow rate differences. The gas introduced through the inlet 70 may be guided to the first sensing element 10 through at least one flow path 72. The flow path 72 may include, for example, a plurality of flow paths 72 arranged in parallel between the inlet 70 and the first sensing element. The flow path 72 may include a valve. The supply of gas through the flow path 72 may be controlled depending on whether the valve is open or closed.

Referring to FIG. 8, the flow path 72 may include a first flow path 72a. The first flow path 72a may guide gas from the inlet 70 to the first sensing element 10, and may be provided with at least one of a temperature sensor 75 or a humidity sensor 75. The at least one of the temperature sensor 75 or the humidity sensor 75 provided in the first flow path 72a may measure the temperature and/or humidity of the supplied gas. The measured temperature and/or humidity may be output to a controller 40. The controller 40 may perform calibration so as to offset changes in the resonant frequency caused by one or more of temperature and humidity with respect to the resonant frequency output from the first sensing element 10. By placing at least one temperature sensor 75 or humidity sensor 75 in the first flow path 72a, influences from temperature and/or humidity may be eliminated, enabling measurements of data that are independent of temperature and/or humidity changes.

Referring to FIG. 8, the flow path 72 may include a second flow path 72b. The second flow path 72b may guide gas from the inlet 70 to the first sensing element 10 and may be provided with a filter 80. The filter 80 may include, for example, a dehumidifying filter 80, a deodorizing filter 80, or a combination thereof. The dehumidifying filter 80 may include, for example, silica gel, a molecular sieve, or the like. The deodorizing filter 80 may include, for example, activated carbon, zeolite, or the like. By removing moisture, odor, etc., from the gas in the second flow path 72b, the supplied gas may be used as a reference gas (e.g., zero-point gas) without requiring a separate standard gas.

Referring to FIG. 8, the flow path 72 may include a third flow path 72c. The third flow path 72c may guide gas from the inlet 70 to the first sensing element 10 without filtration. By supplying the target gas to the first sensing element 10 without filtration through the third flow path 72c and comparing the data collected therein with the data obtained from the filtered gas through the second flow path 72b, it is possible to eliminate influences from factors such as moisture or odor. For example, during a first time interval, the gas introduced through the inlet 70 may be guided to the first sensing element 10 via the second flow path 72b. Then, during a second time interval, the gas introduced through the inlet 70 may be guided to the first sensing element 10 via the third flow path 72c. Then, the controller may compare the data collected from the second flow path 72b with the data collected from the third flow path 72c to correct for effects caused by moisture, odor, and the like.

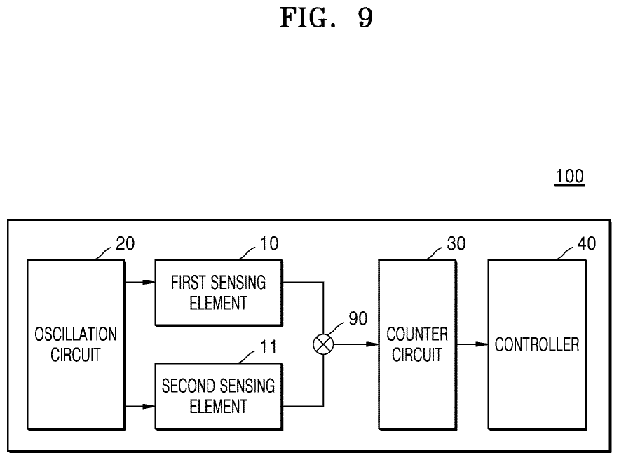

FIG. 9 is a schematic diagram of a gas sensing device according to an embodiment.

Referring to FIG. 9, a gas sensing device 100 may include: a first sensing element 10 having a resonant frequency that varies in response to adsorbed gas; a second sensing element 11; an oscillation circuit 20 configured to apply a driving voltage to the first sensing element 10 and the second sensing element 11; a counter circuit 30 configured to measure the resonant frequencies output from the first sensing element 10 and the second sensing element 11; and a controller 40 configured to calculate the weight of the adsorbed gas. The gas sensing device 100 may further include a coupler 90 between the first sensing element 10 and the second sensing element 11 on one side and the counter circuit 30 on the other side. The coupler 90 may combine frequency signals output from the first sensing element 10 and the second sensing element 11 and output a differential resonant frequency to the counter circuit 30. A low-pass filter may be added between the coupler 90 and the counter circuit 30. By adding this low-pass filter, noise other than the differential resonant frequency may be effectively removed. The gas sensing device 100 may further include a second sensing element 11, and the gas sensing layer 52 may be absent in the second sensing element (i.e., the second sensing element may be free of the gas sensing layer). For example, the second sensing element does not include the gas sensing layer 52. The second sensing element 11 may be used as a reference element. Because the gas sensing device 100 additionally includes the second sensing element 11 along with the first sensing element 10 and measures the difference in resonant frequencies between the first sensing element 10 and the second sensing element 11, measurement errors caused by variations in the manufacturing process of the sensing elements may be reduced. Because the gas sensing device 100 includes the first sensing element 10 (which has the gas sensing layer 52) and the second sensing element 11 (which does not have the gas sensing layer 52), any measurement errors arising from factors other than the gas sensing layer 52 may be completely offset. As a result, the measurement efficiency of the gas sensing device 100 may be improved.

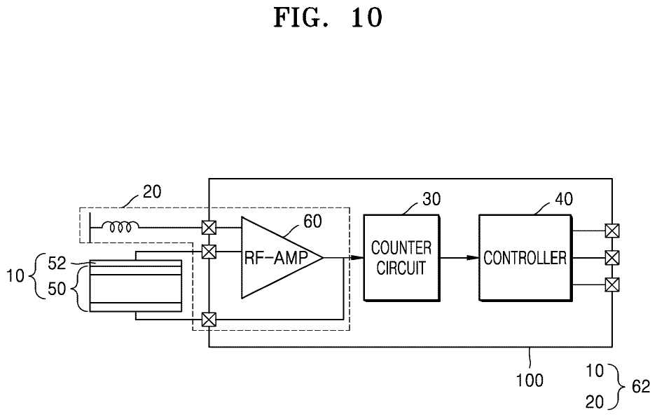

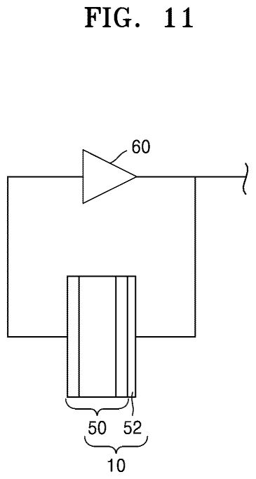

FIG. 10 is a schematic diagram of a gas sensing device including an amplifier according to an embodiment. FIG. 11 is a feedback loop circuit diagram of a gas sensing device according to an embodiment.

Referring to FIG. 10, a gas sensing device 100 may include: a first sensing element 10 having a resonant frequency that varies in response to adsorbed gas; an oscillation circuit 20 configured to apply a driving voltage to the first sensing element 10; a counter circuit 30 configured to measure a resonant frequency output from the first sensing element 10; and a controller 40 configured to calculate the weight of the adsorbed gas. The oscillation circuit 20 may further include an amplifier 60. As the oscillation circuit 20 configured to apply a driving voltage to the first sensing element 10 further includes the amplifier 60, a signal output from the first sensing element 10 may be amplified. The oscillation circuit 20 including the amplifier 60 may be electrically connected to the first sensing element 10 to form a sensing channel 62. The amplifier 60 may be electrically connected to the first sensing element 10, and the system gain of the sensing channel 62 may be set to satisfy the oscillation conditions of the first sensing element 10.

Referring to FIG. 11, the first sensing element 10 and the amplifier 60 may be electrically connected to form a feedback loop. By establishing a feedback loop between the first sensing element 10 and the amplifier 60, the system gain of the sensing channel 62 including the first sensing element 10 and the amplifier 60 may be increased. For example, the gain of the feedback loop may be 1 or more, 5 or more, 10 or more, 50 or more, or 100 or more.

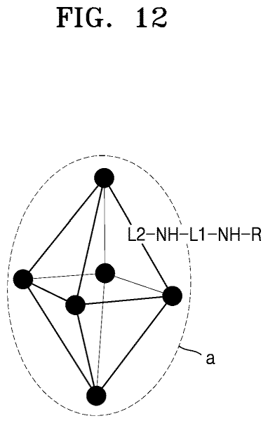

FIG. 12 is an illustration of a gas sensing material according to an embodiment.

Referring to FIG. 12, the gas sensing material may include: a support including a three-dimensional metal-organic framework; and a dual hydrogen bond donor-based receptor bound to the support. The portion labeled “a” in FIG. 12 corresponds to the three-dimensional metal-organic framework, and the dual hydrogen bond donor-based receptor is bound to the three-dimensional metal-organic framework. The three-dimensional metal-organic framework serves as a support. Referring to FIG. 12, the three-dimensional metal-organic framework may include a plurality of metal cation nodes (indicated by black circles) and an organic ligand L2 between adjacent metal cation nodes among the plurality of metal cation nodes. For example, the organic ligand may include a single phenylene group between the adjacent metal cation nodes. With the organic ligand including a single phenylene group, the three-dimensional metal-organic framework may have a compact size. Because the three-dimensional metal-organic framework is compact in size, an increased amount of the gas sensing material may be coated per unit area of the resonator 50. As a result, the performance of the gas sensing device may be improved. The dual hydrogen bond donor-based receptor may be bound to the three-dimensional metal-organic framework. Gas may be adsorbed on the dual hydrogen bond donor-based receptor through hydrogen bonding. By having a mirror-symmetric structure, the dual hydrogen bond donor-based receptor may provide multiple gas binding sites, thereby offering enhanced adsorption performance for gases. The dual hydrogen bond donor-based receptor may exhibit improved adsorption performance for alkaline gases such as ammonia. The gas sensing material may provide improved gas sensing performance for alkaline gases.

As the dual hydrogen bond donor-based receptor is chemically bonded to the phenylene ring of the organic ligand, structural stability may be enhanced compared to physical bonding methods or the like.

The three-dimensional metal-organic framework may be, for example, a porous metal-organic framework. For example, the three-dimensional metal-organic framework may have a three-dimensional structure including a tetrahedron, hexahedron, octahedron, dodecahedron, icosahedron, or a combination thereof. For example, the three-dimensional metal-organic framework may be UiO-66-NH₂, MOF-808, (Fe or Cr)-MIL-101, or M-MOF-74 (wherein M is Zr, Cu, Ni, Co, Fe, Zn, Mg, Cr, or a combination thereof), or a combination thereof.

The dual hydrogen bond donor-based receptor may include a dual hydrogen bond donor moiety having a mirror-symmetric structure and an aromatic ring, which may be unsubstituted or substituted with a substituent, connected to one terminal of the dual hydrogen bond donor moiety. The dual hydrogen bond donor-based receptor may include a dual hydrogen bond donor moiety having a mirror-symmetric structure and an aromatic ring substituted with an electron withdrawing group connected to one terminal of the dual hydrogen bond donor moiety. By connecting an aromatic ring substituted with an electron withdrawing group to one terminal of the dual hydrogen bond donor moiety, the acidity of the gas sensing material may be increased. As a result, the gas sensing material may act as a Brønsted acid. When acting as a Brønsted acid, gas may be more readily adsorbed onto the gas sensing material via hydrogen bonding. The acidity of the gas sensing material-more specifically, the acidity of the dual hydrogen bond donor moiety—may be adjusted according to the specific structure of the electron withdrawing group.

Examples of the electron withdrawing group may include, but are not limited to, a halogen, a carboxyl group (—COOH), an ester group (—C(═O)OR′, where R′ is a C1-C5 alkyl group), an aldehyde group (—CH(═O)), a ketone group (—C(═O)R′, where R′ is a C1-C5 alkyl group), a cyano group (—CN), a sulfonyl group (—S(═O)₂R′, where R′ is a C1-C5 alkyl group), or a nitro group (—NO₂).

Referring to FIG. 12, the dual hydrogen bond donor-based receptor may be represented, for example, by Formula 1:

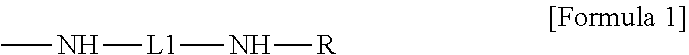

wherein
—NH-L1-NH-denotes a dual hydrogen bond donor moiety,
L1 is a thiocarbonyl group or a cycloalkenone group, and
R is an aromatic group having 6 to 20 carbon atoms, substituted with an electron withdrawing group.

The dual hydrogen bond donor moiety may have a mirror-symmetric structure. By having a mirror-symmetric structure, the dual hydrogen bond donor moiety may provide more uniform binding sites for a gas, such as an alkaline gas.

In Formula 1, the cycloalkenone group may be, for example, a cyclobutenedione group or a cyclopentenetrione group.

In Formula 1, the electron withdrawing group may include, for example, a halogen, a halogen-substituted C1 to C10 alkyl group, a halogen-substituted C2 to C10 alkenyl group, a halogen-substituted C6 to C20 aryl group, or a combination thereof.

The dual hydrogen bond donor-based receptor may, for example, be represented by Formula 2:

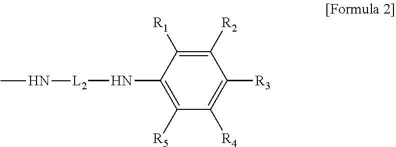

wherein
L₂ is a thiocarbonyl group, a cyclobutenedione group, or a cyclopentenetrione group,
R₁, R₂, R₃, R₄, and R₅ are each independently a halogen, a halogen-substituted or unsubstituted C1 to C10 alkyl group, a halogen-substituted or unsubstituted C2 to C10 alkenyl group, and a halogen-substituted or unsubstituted C6 to C20 aryl group, and
at least one of R₁, R₂, R₃, R₄, or R₅ includes a halogen.

The dual hydrogen bond donor-based receptor may, for example, be represented by Formulas 3A to 3C:

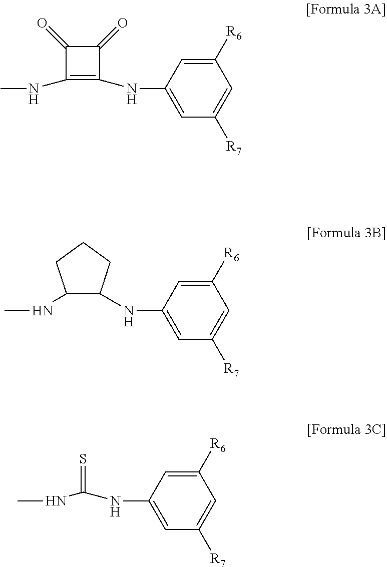

wherein
R₆ and R₇ are each independently a halogen, a halogen, a halogen-substituted or unsubstituted C1 to C5 alkyl group, a halogen-substituted or unsubstituted C2 to C5 alkenyl group, and a halogen-substituted or unsubstituted C6 to C20 aryl group, and
at least one of R₆ or R₇ includes a halogen.

### [Method of Operating Gas Sensing Device]

According to an embodiment, a method of operating a gas sensing device may include: applying a driving voltage from an oscillation circuit 20 to a first sensing element 10 including a gas sensing layer 52; inputting, into a counter circuit 30, a resonant frequency output from the first sensing element 10; and calculating, by a controller 40, the weight of the adsorbed gas based on changes in the resonant frequency corresponding to gas adsorbed on the gas sensing layer 52 of the first sensing element 10. The gas sensing layer 52 may include a gas sensing material. The gas sensing material may include a support including a three-dimensional metal-organic framework; and a dual hydrogen bond donor-based receptor bound to the support. The three-dimensional metal-organic framework may include a plurality of metal cation nodes and an organic ligand between adjacent metal cation nodes among the plurality of metal cation nodes.

Referring to FIG. 1 and FIGS. 8 to 10, first, a driving voltage may be applied from the oscillation circuit 20 to the first sensing element 10 including the gas sensing layer 52. As the oscillation circuit 20 applies a driving voltage to the first sensing element 10, the first sensing element 10 may output a resonant frequency. The first sensing element 10 may have a resonant frequency which varies in response to the gas adsorbed on the first sensing element 10. For example, as gas is adsorbed onto the first sensing element 10, the resonant frequency of the first sensing element 10 may decrease.

The resonant frequency output from the first sensing element 10 may be inputted into the counter circuit 30. The counter circuit 30 may measure the resonant frequency from the first sensing element 10. For example, the counter circuit 30 may continuously measure changes in the resonant frequency of the first sensing element 10. The resonant frequency measured by the counter circuit 30 may be inputted into the controller 40 in real time.

Subsequently, the controller 40 may calculate the weight of the adsorbed gas based on changes in the resonant frequency corresponding to gas adsorbed on the gas sensing layer 52 of the first sensing element 10. The controller 40 may include a memory and an output device. The resonant frequency input from the counter circuit 30 may be recorded in the memory. Temperature and humidity data input from the temperature sensor and the humidity sensor may be recorded in the memory. The resonant frequency may be calculated as a value corrected by the temperature and humidity data recorded in the memory, and the corrected value may be separately recorded in the memory. The controller 40 may calculate the weight of the adsorbed gas from the resonant frequency and output the calculated weight of the gas to the output device.

The method for operating a gas sensing device may further include regenerating the gas sensing layer 52 by heating the first sensing element 10 in the gas sensing device 100. Once the gas sensing device 100 is operated for a period of time, adsorption on the gas sensing material on the gas sensing layer 52 may degrade the sensing performance of the gas sensing device 100. Heating the first sensing element 10 may cause the gas to desorb from the gas sensing layer 52, thereby regenerating the gas sensing layer 52. Periodically heating the gas sensing device 100 may suppress deterioration of the gas sensing material, oxidation of the electrodes, etc., caused by gas. The lifespan of the gas sensing device 100 may thereby be increased. The heating temperature may be, for example, 100° C. or more, 150° C. or more, 200° C. or more, or 250° C. or more. By heating within such a temperature range, the regeneration efficiency of the gas sensing layer 52 may be improved. The heating time may be, for example, 1 minute or more, 5 minutes or more, 10 minutes or more, or 1 hour or more. By heating for such a duration, the regeneration efficiency of the gas sensing layer 52 may be improved.

For details on the gas sensing material, refer to the gas sensing device 100 described above.

The gas sensing material may be selected from the gas sensing materials used in the gas sensing device 100 described above.

### [Gas Sensing Material]

A gas sensing material according to an embodiment may include a support including a three-dimensional metal organic framework; and a dual hydrogen bond donor-based receptor bound to the support. The three-dimensional metal-organic framework may include a plurality of metal cation nodes and an organic ligand between adjacent metal cation nodes among the plurality of metal cation nodes. The dual hydrogen bond donor-based receptor may be represented by Formula 1:

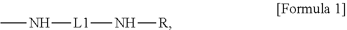

wherein
—NH-L1-NH— is a dual hydrogen bond donor moiety,
L1 is a thiocarbonyl group or a cycloalkenone group,
R is an aromatic group having 6 to 20 carbon atoms, substituted with an electron-withdrawing group.

Referring to FIG. 12, the portion labeled “a” corresponds to the three-dimensional metal-organic framework, and the dual hydrogen bond donor-based receptor represented by Formula 1 is bound to the three-dimensional metal-organic framework. The three-dimensional metal-organic framework serves as a support. Referring to FIG. 12, the three-dimensional metal-organic framework may include a plurality of metal cation nodes (indicated by black circles) and an organic ligand L2 between adjacent metal cation nodes among the plurality of metal cation nodes.

The organic ligand may include, for example, a single phenylene group between the adjacent metal cation nodes. With the organic ligand including a single phenylene group, the three-dimensional metal-organic framework may have a compact size. Due to the compact size of the three-dimensional metal-organic framework, an increased amount of the gas sensing material may be coated per unit area of the resonator. Consequently, the performance of the gas sensing device may be improved.

The three-dimensional metal-organic framework may be, for example, a porous metal-organic framework. The three-dimensional metal-organic framework may have a three-dimensional structure including, for example, a tetrahedron, a hexahedron, an octahedron, a dodecahedron, an icosahedron, or a combination thereof. The three-dimensional metal-organic framework may be, for example, UiO-66-NH₂, MOF-808, (Fe or Cr)-MIL-101, M-MOF-74 (where M is Zr, Cu, Ni, Co, Fe, Zn, Mg, Cr, or a combination thereof), or a combination thereof.

The electron withdrawing group may be, for example, a halogen, a carboxyl group (—COOH), an ester group (—C(═O)OR′, where R′ is a C1-C5 alkyl group), an aldehyde group (—CH(═O)), a ketone group (—C(═O)R′, where R′ is a C1-C5 alkyl group), a cyano group (—CN), a sulfonyl group (—S(═O)₂R′, where R′ is a C1-C5 alkyl group), or a nitro group (—NO₂), without being limited thereto.

The dual hydrogen bond donor-based receptor may include a dual hydrogen bond donor moiety having a mirror-symmetrical structure, as represented by Formula 1, and an aromatic ring having 6 to 20 carbon atoms-substituted with an electron withdrawing group—that is connected to one terminal of the dual hydrogen bond donor moiety. As an aromatic ring having 6 to 20 carbon atoms-substituted with an electron withdrawing group—is connected to one terminal of the dual hydrogen bond donor moieties, the acidity of the gas sensing material may be increased. The gas sensing material may act as a Brønsted acid. A gas may thereby be more readily adsorbed via hydrogen bonding to the gas sensing material acting as a Brønsted acid. The acidity of the gas sensing material-more specifically, the acidity of the dual hydrogen bond donor moiety—may be adjusted according to the specific structure of the electron withdrawing group. The gas sensing material may, for example, provide improved gas sensing performance for alkaline gases.

In Formula 1, the cycloalkenone group may be, for example, a cyclobutenedione group or a cyclopentenetrione group.

In Formula 1, the electron withdrawing group may include, for example, a halogen, a halogen-substituted C1 to C10 alkyl group, a halogen-substituted C2 to C10 alkenyl group, a halogen-substituted C6 to C20 aryl group, or a combination thereof.

The dual hydrogen bond donor-based receptor may be, for example, represented by Formula 2:

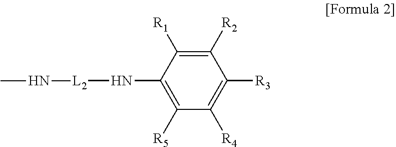

wherein
L₂ is a thiocarbonyl group, a cyclobutenedione group, or a cyclopentenetrione group,
R₁, R₂, R₃, R₄, and R₅ are each independently a halogen, a halogen-substituted or unsubstituted C1 to C10 alkyl group, a halogen-substituted or unsubstituted C2 to C10 alkenyl group, and a halogen-substituted or unsubstituted C6 to C20 aryl group, and
at least one of R₁, R₂, R₃, R₄, or R₅ includes a halogen.

The dual hydrogen bond donor-based receptor may be represented, for example, by Formulas 3A to 3C:

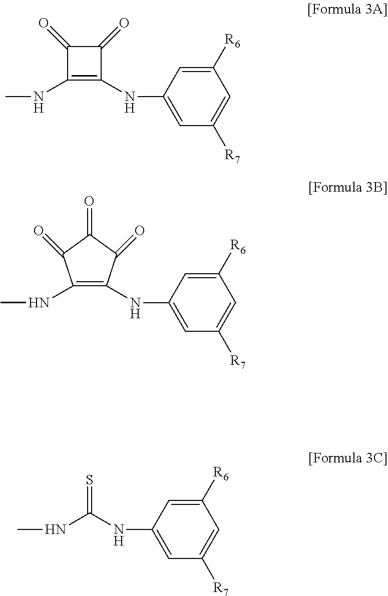

wherein
R₆ and R₇ are each independently a halogen, a halogen-substituted or unsubstituted C1 to C5 alkyl group, a halogen-substituted or unsubstituted C2 to C5 alkenyl group, and a halogen-substituted or unsubstituted C6 to C20 aryl group, and
at least one of R₆ or R₇ includes a halogen.

In the present specification, substitution may be induced by replacing one or more hydrogen atoms in an unsubstituted mother group with other atoms or functional groups. Unless otherwise stated, when any functional group is considered “substituted,” it means that the functional group is substituted with one or more substituents selected from: an alkyl group having 1 to 40 carbon atoms, an alkenyl group having 2 to 40 carbon atoms, an alkynyl group having 2 to 40 carbon atoms, a cycloalkyl group having 3 to 40 carbon atoms, a cycloalkenyl group having 3 to 40 carbon atoms, or an aryl group having 6 to 40 carbon atoms. If a functional group is described as being “optionally substituted,” it means that the functional group may or may not be substituted with any of the aforementioned substituents.

In the present specification, a and b in the expressions “having from a to b carbon atoms”, “Cₐ to C_{b}”, and “Cₐ-C_{b}” indicate the number of carbon atoms in the specified functional group. That is, the functional group may include any number of carbon atoms from a to b, inclusive. For example, “alkyl group having 1 to 4 carbons” or “C1 to C4 alkyl group” or “C1-C4 alkyl group” refers to an alkyl group having 1 to 4 carbon atoms, for example, refers to CH₃—, CH₃CH₂—, CH₃CH₂CH₂—, (CH₃)₂CH—, CH₃CH₂CH₂CH₂—, CH₃CH₂CH(CH₃)—, and (CH₃)₃C—.

The nomenclature for a particular radical may include a monoradical (mono-radical) or a diradical (di-radical), depending on the context. For example, if a substituent requires two points of attachment to the remainder of the molecule, that substituent should be understood as a diradical. For example, when a substituent is defined as an alkyl group requires two points of attachment, it includes a diradical such as —CH₂—, —CH₂CH₂—, or —CH₂CH(CH₃)CH₂—, and the like. Other radical nomenclature, such as “alkylene,” clearly indicates that the radical is a diradical.

In the present specification, the terms “alkyl group” or “alkylene group” refer to a branched or unbranched saturated aliphatic hydrocarbon group. In an embodiment, the alkyl group may be substituted or unsubstituted. The alkyl group may include, for example, a methyl group, an ethyl group, a propyl group, an isopropyl group, a butyl group, an isobutyl group, a tert-butyl group, a pentyl group, a hexyl group, a cyclopropyl group, a cyclopentyl group, a cyclohexyl group, or a cycloheptyl group, without being limited thereto; each may be optionally substituted or unsubstituted. In an embodiment, the alkyl group may contain 1 to 6 carbon atoms. For example, an alkyl group having 1 to 6 carbon atoms may be methyl, ethyl, propyl, isopropyl, butyl, isobutyl, sec-butyl, pentyl, 3-pentyl, or hexyl, without necessarily being limited thereto.

In the present specification, the term “alkylene group” refers to an alkyl group requiring two or more points of attachment. According to an embodiment, an alkylene group may have from 1 to 6 carbon atoms. For example, an alkylene group having 1 to 6 carbon atoms may be methylene, ethylene, propylene, isopropylene, butylene, isobutylene, propylene, or hexylene, without necessarily being limited thereto.

In the present specification, the term “cycloalkylene group” refers to a cycloalkyl group requiring two or more points of attachment. According to an embodiment, a cycloalkylene group may have from 5 to 10 carbon atoms. For example, a cycloalkylene group having 5 to 10 carbon atoms may be cyclopentylene, cyclohexylene, cycloheptylene, cyclooctylene, cyclononylene, or cyclodecylene, without necessarily being limited thereto.

In the present specification, the term “aromatic” refers to a ring or ring system having a conjugated TT-electron system. In the present specification, the term “aromatic” includes an aromatic carbon ring (for example, a phenyl group) and an aromatic hetero ring (for example, pyridine). If the entire ring system is aromatic, the term also includes a single cyclic ring or a fused polycyclic ring (i.e., rings that share pairs of adjacent atoms).

In the present specification, the term “aryl group” refers to an aromatic ring or ring system whose ring skeleton consists solely of carbon, that is, either a single ring or two or more fused rings (i.e., rings that share two adjacent carbon atoms), or multiple aromatic rings connected to each other by a single bond, —O—, —S—, —C(═O)—, —S(═O)₂—, —Si(Rₐ)(R_{b})— (where Rₐ and R_{b} are each independently a C1 to C10 alkyl group), a halogen-substituted or unsubstituted C1 to C10 alkylene group, or —C(═O)—NH—. In the present specification, if the aryl group is a ring system, each ring in that system is aromatic. For example, the aryl group may include phenyl, biphenyl, naphthyl, phenanthrenyl, naphthacenyl, and the like, but is not limited thereto. The aryl group may be substituted or unsubstituted.

In the present specification, the term “arylene group” refers to an aryl group that requires at least two points of attachment. A tetravalent arylene group is an aryl group requiring four bonding sites, whereas a divalent arylene group is an aryl group requiring two points of attachment. For example, the tetravalent arylene group may be —C₆H₄—O—C₆H₄— and the like.

In the present specification, the term “heteroaryl group” refers to an aromatic ring system that includes a single ring, multiple fused rings, or multiple rings connected to each other by a single bond, —O—, —S—, —C(═O)—, —S(═O)₂—, —Si(Rₐ)(R_{b})—(Rₐ and R_{b} are each independently a C1 to C10 alkyl group), a halogen-substituted or unsubstituted C1 to C10 alkylene group, or —C(═O)—NH—, and that contains at least one ring atom that is not carbon (i.e., a heteroatom). In the fused ring system, one or more heteroatoms may be present in only one of the rings. For example, the heteroatom may include oxygen, sulfur, and nitrogen, but is not necessarily limited thereto. For example, the heteroaryl group may include a furanyl group, a thienyl group, an imidazolyl group, a quinazolinyl group, a quinolinyl group, an isoquinolinyl group, a quinoxalinyl group, a pyridinyl group, a pyrrolyl group, an oxazolyl group, an indolyl group, and the like, but is not limited to the aforementioned examples.

In the present specification, the term “heteroarylene group” refers to a heteroaryl group requiring two or more points of attachment. For example, a tetravalent heteroarylene group refers to a heteroaryl group requiring four points of attachment, and a divalent heteroarylene group refers to a heteroaryl group requiring two points of attachment.

Hereinbelow, the present disclosure will be described in detail with reference to Examples and Comparative Examples, but is not limited thereto.

### (Preparation of Gas Sensing Material)

### Comparative Example 1: Preparation of UiO-66-NH₂

A gas sensing material, UiO-66-NH₂ (C₄₈H₃₄N₆O₃₂Zr₆), which includes a zirconium (Zr⁴⁺)-based metal-organic framework and an amine group (—NH₂) serving as a single hydrogen bond donor-based receptor fixed on the metal-organic framework, was prepared by a solvothermal synthesis method.

Zirconium chloride (ZrCl₄) at 1.0 mmol and 2-aminoterephthalic acid (NH₂-BDC) at 1.0 mmol were added to 100 mL of dimethylformamide (DMF), and the resulting mixture was heated at 85° C. for 30 minutes to prepare a mixed solution. The mixed solution was then introduced into an autoclave, heated at 120° C. for 24 hours, and subjected to centrifugation to obtain a reaction product. The reaction product was washed with DMF, the DMF was exchanged with acetone three times, and then the product was vacuum-dried at 60° C. for 12 hours to obtain a dried product. The dried product was pulverized with a mortar and pestle to yield a powder of the metal-organic framework (UiO-66-NH₂) containing the amine group.

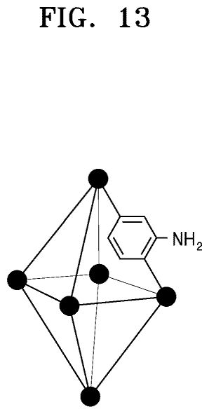

FIG. 13 is an illustration of the metal-organic framework (UiO-66-NH₂) containing the amine group. In FIG. 13, the black circles indicate metal cation nodes, and the straight lines connecting adjacent metal cation nodes represent the organic ligands. The organic ligand is a phenylene group. The amine group is bound to the phenylene organic ligand as a single hydrogen bond donor. In FIG. 13, the organic ligand connecting adjacent metal cation nodes is schematically illustrated as a straight line to show the framework structure of the metal-organic framework.

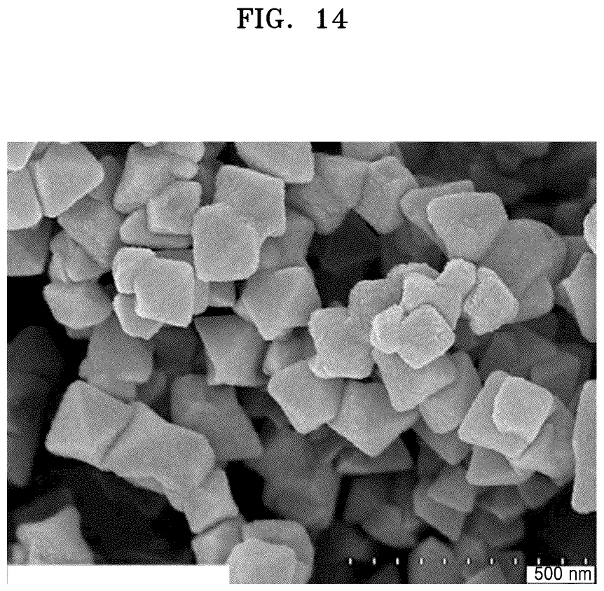

A scanning electron microscope (SEM) measurement was performed on the metal-organic framework (UiO-66-NH₂) containing the amine group, and the measurement results are shown in FIG. 14. As shown in FIG. 14, the crystals of the metal-organic framework (UiO-66-NH₂) containing the amine group form a polyhedron, including an octahedron, and are uniformly distributed in size.

### Example 1: Preparation of UiO-66-SQ

### (Preparation of Precursor for Dual Hydrogen Bond Donor-Based Receptor)

3.52 mmol of 3,4-dimethoxy-3-cyclobutene-1,2-dione and 3.40 mmol of 3,5-bis(trifluoromethyl) aniline were added to 20 mL of methanol, and the resulting mixture was stirred at room temperature for 3 days to induce a nucleophilic substitution reaction. The solution, after completion of the nucleophilic substitution reaction, was filtered, purified with methanol, and dried under vacuum at 60° C. for 12 hours to obtain a dual hydrogen bond donor-based receptor precursor (3-((3,5-bis(trifluoromethyl)phenyl)amino)-4-methoxycyclobut-3-ene-1,2-dione; Me-SQ).

### (Preparation of Metal-Organic Framework Containing Dual Hydrogen Bond Donor-Based Receptor)

200 mg of the metal-organic framework (UiO-66-NH₂) containing the amine group, prepared according to Comparative Example 1, and 464 mg of the above-obtained dual hydrogen bond donor-based receptor precursor (Me-SQ) were added to 12 mL of methanol, subjected to reflux for 72 hours, and then centrifuged to obtain a precipitate. The precipitate was washed with a methanol solution and dried under vacuum at 60° C. for 12 hours, thereby yielding a metal-organic framework (UiO-66-SQ) containing the dual hydrogen bond donor-based receptor.

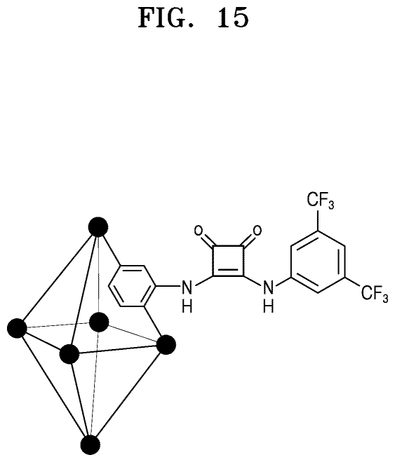

FIG. 15 is an illustration of the metal-organic framework (UiO-66-SQ) containing the dual hydrogen bond donor-based receptor. In FIG. 15, the black circles indicate metal cation nodes, and the straight lines connecting adjacent metal cation nodes represent organic ligands. The organic ligand is a phenylene group. As the dual hydrogen bond donor-based receptor,

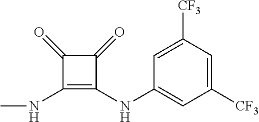 [SMILES: CNc1c(Nc2cc(C(F)(F)F)cc(C(F)(F)F)c2)c(=O)c1=O]

is bound to the phenylene organic ligand. In FIG. 15, the organic ligand connecting adjacent metal cation nodes is schematically depicted as a straight line to illustrate the framework structure of the metal-organic framework.

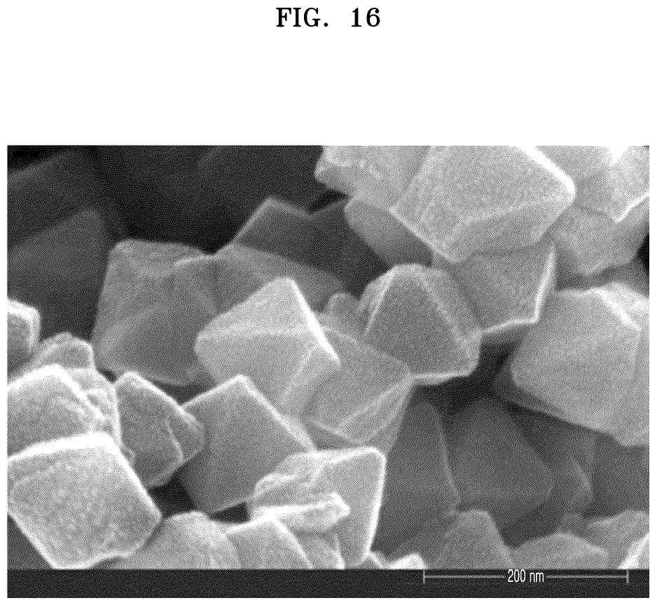

A scanning electron microscope (SEM) measurement was performed on the metal-organic framework (UiO-66-SQ) containing the dual hydrogen bond donor-based receptor, and the measurement results are shown in FIG. 16.

As shown in FIG. 16, the crystals of the metal-organic framework (UiO-66-SQ) containing the dual hydrogen bond donor-based receptor form a polyhedron, including an octahedron, and exhibit a uniform distribution in size.

### Evaluation Example 1: XRD Measurement

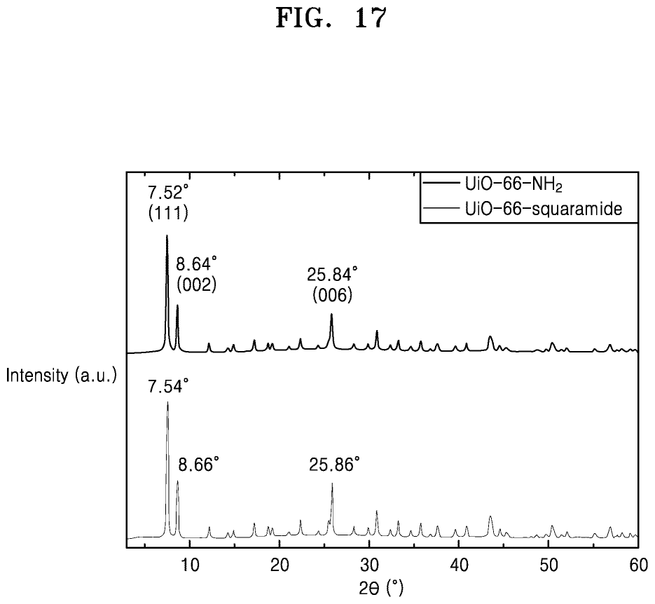

X-ray diffraction (XRD) measurements were conducted on the gas sensing material (UiO-66-NH₂) from Comparative Example 1 and the gas sensing material (UiO-66-SQ) from Example 1, and the measurement results are shown in FIG. 17.

As shown in FIG. 17, it was confirmed that even after the dual hydrogen bond donor-based receptor is bound to the skeleton of the metal-organic framework, the metal-organic framework maintains a stable framework structure.

### Evaluation Example 2: IR Measurement

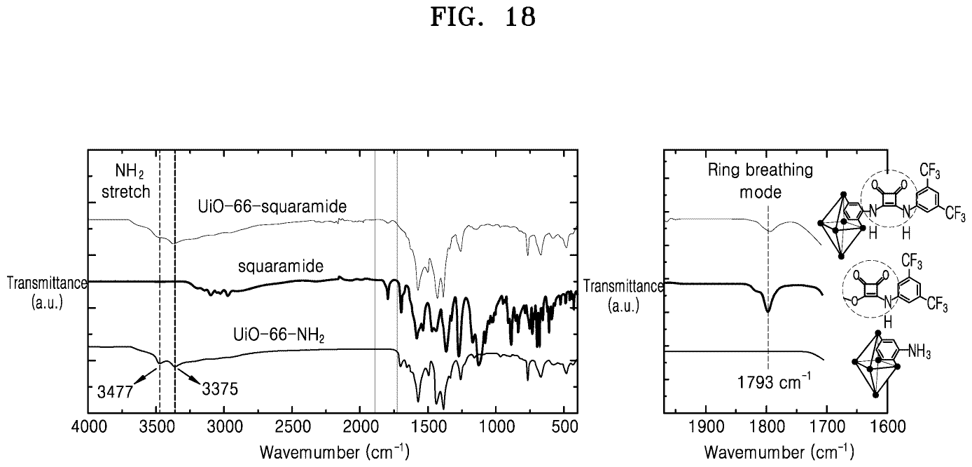

Infrared spectra were measured for the gas sensing material (UiO-66-NH₂) of Comparative Example 1 and the gas sensing material (UiO-66-SQ) of Example 1, and the measurement results are shown in FIG. 18.

As shown in FIG. 18, the gas sensing material (UiO-66-NH₂) prepared in Comparative Example 1 exhibits peaks corresponding to NH₂ vibrations at 3,477 cm⁻¹ and 3,375 cm⁻¹.

In the gas sensing material (UiO-66-SQ) prepared in Example 1, the intensity of the peak corresponding to NH₂ vibrations decreases, and a peak corresponding to the ring breathing mode of squaramide is observed at 1,793 cm⁻¹.

From the decrease in the intensity of the NH₂ vibration peaks and the emergence of the ring breathing mode peak, it was confirmed that the gas sensing material (UiO-66-SQ) having the dual hydrogen bond donor-based receptor bound to the metal-organic framework was formed.

### Evaluation Example 3: Assessment of Gas Adsorption Performance

An ammonia-temperature programmed desorption (TPD) analysis was conducted to quantify the chemical adsorption of ammonia gas onto the gas sensing material of Comparative Example 1 (UIO-66-NH₂) and the gas sensing material of Example 1 (UiO-66-SQ). Ammonia-temperature programmed desorption analysis is an analytical method that quantifies the amount of ammonia gas desorbed from a sample as the temperature of the reactor is increased, after adsorbing ammonia gas molecules onto a gas sensing material contained on a substrate in the reactor. Ammonia-temperature programmed desorption analysis was performed using a 10% NH₃/He ammonia gas (diluted with helium gas) and a BELCAT II catalyst characterization instrument from Microtrac.

After stabilizing the temperature of the reactor containing the gas sensing material of Comparative Example 1 (UiO-66-NH₂) at 25° C., ammonia gas was introduced for 60 minutes at a pressure of 0.65 bar. Then, helium gas was introduced for 120 minutes to desorb the ammonia gas that was physically adsorbed onto the gas sensing material. Subsequently, while increasing the temperature of the reactor at a rate of 10° C. per minute, the content of ammonia gas desorbed was analyzed using a thermal conductivity detector (TCD), and the amount of chemical adsorption was evaluated in the temperature range of 25° C. to 400° C.

The same method was applied to the gas sensing material of Example 1 (UiO-66-SQ) to assess its amount of chemical adsorption.

To convert the area of the ammonia-temperature programmed desorption analysis graph into the quantitative chemical adsorption amount of ammonia gas, a conversion factor was obtained by introducing 10% NH₃/He gas into an empty reactor, and the conversion factor was determined to be 53,436,633 μV·sec/mmol. Using this conversion factor, the amount of chemical adsorption of ammonia gas was calculated from the area under the ammonia-temperature programmed desorption analysis graph according to Equation 1 below.

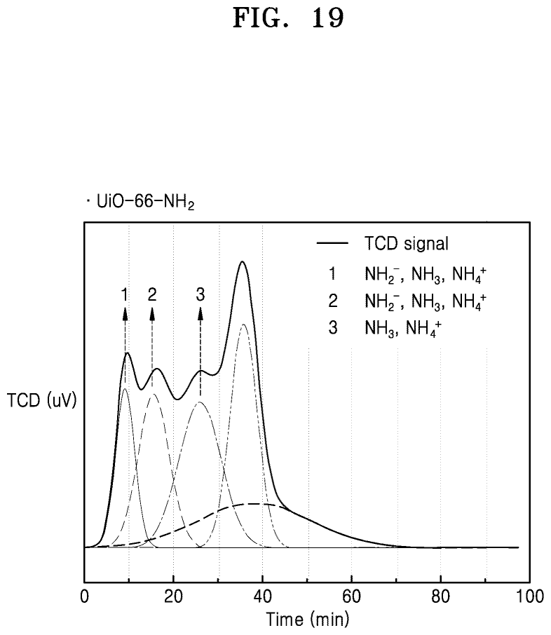

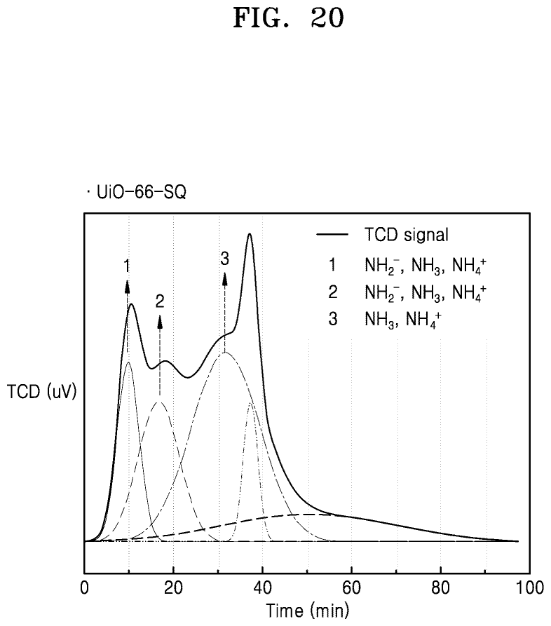

The measurement results are shown in Table 1, FIG. 19, and FIG. 20, respectively.

$$[ A / CF ] / W ( mmol / g ) \qquad [ Equation 1 ]$$

wherein
A represents the area under the ammonia-temperature programmed desorption analysis graph, CF represents the conversion factor, and W represents the amount of gas sensing material used.

FIG. 19 shows the ammonia-temperature programmed desorption (NH₃-TPD) analysis graph of the gas sensing material of Comparative Example 1 (UiO-66-NH₂). The NH₃-TPD analysis was conducted over a temperature range of 25° C. to 400° C., and the areas corresponding to Peak 1, Peak 2, and Peak 3 in the graph were measured. According to Equation 1, using the conversion factor, the total amount of chemically adsorbed ammonia gas calculated from Peak 1 to Peak 3 was 1.696 mmol/g.

FIG. 20 shows an NH₃-TPD analysis graph of the gas sensing material of Example 1 (UiO-66-SQ). In FIG. 20, using the same method, the total amount of chemically adsorbed ammonia gas, calculated by conducting the NH₃-TPD analysis, was 2.605 mmol/g.

TABLE 1

| | Comparative Example 1 | Example 1 |
|---|---|---|
| | Desorbed NH₃ [mmo/g] | Desorbed NH₃ [mmo/g] |
| Peak 1 | 0.370 | 0.450 |
| Peak 2 | 0.579 | 0.665 |
| Peak 3 | 0.747 | 1.490 |
| | Adsorbed NH₃ [mmo/g] | Adsorbed NH₃ [mmo/g] |
| Sum of Peak 1, | 1.696 | 2.605 |
| Peak 2, and Peak 3 | | |

As shown in Table 1, FIG. 19, and FIG. 20, 1.696 mmol/g of ammonia gas was adsorbed by the gas sensing material of Comparative Example 1, whereas 2.605 mmol/g of ammonia gas was adsorbed by the gas sensing material of Example 1.

Therefore, it was confirmed that the gas adsorption amount of the gas sensing material of Example 1 increased by 50% or more compared to the gas sensing material of Comparative Example 1.

### Evaluation Example 4: Preparation of Gas Sensing Device I (FBAR)

A film bulk acoustic resonator (FBAR; film bulk acoustic resonator) having a resonant frequency of 1.9 GHz was provided, and three different concentrations of an aqueous solution containing the gas sensing material prepared in Example 1 were drop-coated onto a top electrode of the FBAR.

After the solution and then removing the solvent, it was confirmed that a gas sensing layer containing the gas sensing material was formed on the top electrode. The amounts of the coated gas sensing layer were 4 ng (nanogram), 0.4 ng, and 0.04 ng, respectively.

The gas sensing layer was bound onto the top electrode by van der Waals forces or the like. No separate polymer binder or the like was included in the gas sensing layer.

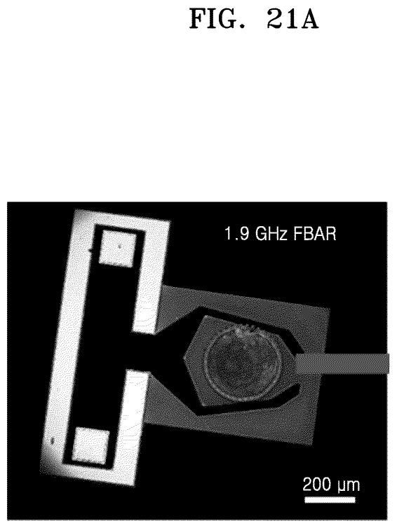

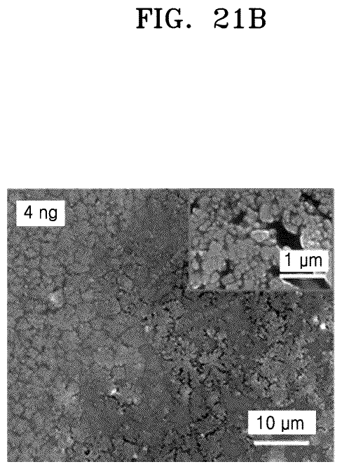

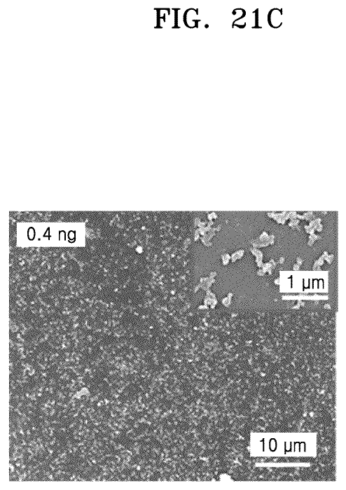

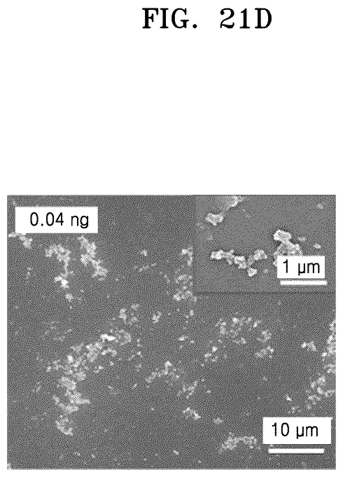

FIG. 21A is an image of the FBAR, in which the gas sensing layer containing the gas sensing material prepared in Example 1 is introduced onto the top electrode.

FIGS. 21B, 21C, and 21D are scanning electron microscope images of the gas sensing layer surface formed by coating 4 ng, 0.4 ng, and 0.04 ng, respectively, of the gas sensing material prepared in Example 1 onto the top electrode.

As shown in FIGS. 21B to 21D, as the content of the gas sensing material decreases, a decrease in the loading level of the gas sensing material on the top electrode was confirmed.

A gas sensing device was prepared by connecting the FBAR having the gas sensing layer introduced therein to an oscillation circuit, a counter circuit, and a controller.

The gas sensing device exhibited a change in resonant frequency in response to ammonia gas, thus confirming its operation as a gas sensing device.

### Evaluation Example 5: Preparation of Gas Sensing Device II (SAW)

An aqueous solution containing the gas sensing material prepared in Example 1 was drop-coated between a first electrode and a second electrode on the upper surface of the piezoelectric substrate of a surface acoustic wave (SAW) resonator.

After coating the solution and then removing the solvent, it was confirmed that a gas sensing layer containing the gas sensing material was formed on the electrode on the upper surface of the piezoelectric substrate 18.

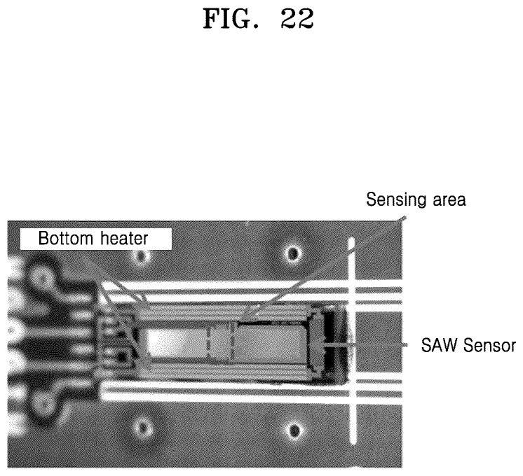

FIG. 22 is an image of a SAW element according to an embodiment. In the gas sensing area of the SAW element, the gas sensing layer was disposed between the first electrode and the second electrode.

Micro-heaters were arranged around the gas sensing area. The micro-heaters were placed adjacent to one side and the other side of the gas sensing layer, respectively, extending from a region adjacent to the first electrode to a region adjacent to the second electrode.

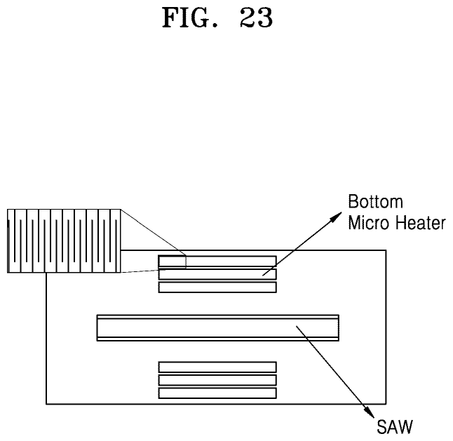

FIG. 23 is a schematic diagram of a SAW element according to an embodiment. The micro-heater included a plurality of zigzag patterns.

A gas sensing device was prepared by connecting a gas sensing element including the SAW element having the gas sensing layer introduced therein to an oscillation circuit, a counter circuit, and a controller.

It was confirmed that the gas sensing device exhibits a change in resonant frequency in response to ammonia gas, thus confirming its operation as a gas sensing device.

Although specific embodiments have been described and illustrated herein, it is to be understood that the present disclosure is not limited to these embodiments. Various modifications, alterations, and variations can be made without departing from the spirit and scope of the disclosure, as defined by the appended claims and their equivalents.

According to an aspect, a gas sensing device having improved alkaline gas sensing performance is provided.

According to another aspect, a method of operating a gas sensing device is provided.

According to another aspect, a gas sensing material having improved alkaline gas adsorption performance is provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A gas sensing device comprising:
a first sensing element having a resonant frequency that varies based on adsorbed gas;
an oscillation circuit configured to apply a driving voltage to the first sensing element;
a counter circuit configured to measure a resonant frequency output from the first sensing element; and
a controller configured to determine a weight of the adsorbed gas,
wherein the first sensing element comprises:
a resonator; and
a gas-sensing layer comprising a gas-sensing material,
wherein the gas-sensing material comprises:
a support comprising a three-dimensional metal-organic framework; and
a dual hydrogen bond donor-based receptor bound to the support, and
wherein the three-dimensional metal-organic framework comprises:
a plurality of metal cation nodes; and
an organic ligand between adjacent metal cation nodes of the plurality of metal cation nodes.

2. The gas sensing device of claim 1, wherein the organic ligand comprises a single phenylene group between the adjacent metal cation nodes.

3. The gas sensing device of claim 1, wherein the dual hydrogen bond donor-based receptor is represented by Formula 1: 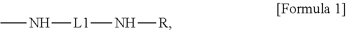
and
wherein
—NH-L1-NH— is a dual hydrogen bond donor moiety,
L1 is a thiocarbonyl group or a cycloalkenone group, and
R is an aromatic group having 6 to 20 carbon atoms, substituted with an electron-withdrawing group.

4. The gas sensing device of claim 1, wherein the dual hydrogen bond donor-based receptor is represented by Formula 2: 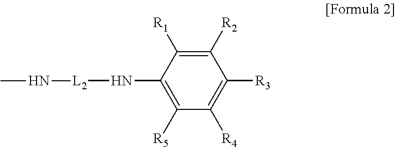
wherein L₂ is a thiocarbonyl group, a cyclobutenedione group, or a cyclopentenetrione group,
R₁, R₂, R₃, R₄, and R₅ are each independently a halogen, a halogen-substituted or unsubstituted C1 to C10 alkyl group, a halogen-substituted or unsubstituted C2 to C10 alkenyl group, and a halogen-substituted or unsubstituted C6 to C20 aryl group, and
at least one of R₁, R₂, R₃, R₄, and R₅ comprises a halogen.

5. The gas sensing device of claim 1, wherein the resonator comprises a thin-film bulk acoustic resonator (FBAR), a surface acoustic wave (SAW) resonator, a bulk acoustic wave (BAW) resonator, a solid mounted resonator (SMR), a quartz crystal microbalance (QCM) resonator, or a combination thereof.

6. The gas sensing device of claim 1, wherein the first sensing element is a thin-film bulk acoustic resonator (FBAR) element, and
wherein the FBAR element comprises:
a substrate;
a first electrode on the substrate;
a second electrode on the first electrode;
a piezoelectric layer between the first electrode and the second electrode;
a gas-sensing layer on the second electrode; and
a micro-heater adjacent to the gas-sensing layer.

7. The gas sensing device of claim 1, wherein the first sensing element is a surface acoustic wave (SAW) resonator element, and
wherein the SAW resonator element comprises:
a piezoelectric substrate;
a first electrode on an upper surface of the piezoelectric substrate;
a second electrode on the upper surface of the piezoelectric substrate;
a gas-sensing layer between the first electrode and the second electrode; and
a micro-heater on the piezoelectric substrate and adjacent to the gas-sensing layer.

8. The gas sensing device of claim 7, wherein the first electrode is a first interdigital transducer (IDT) electrode configured to generate surface acoustic waves,
wherein the second electrode is a second IDT electrode configured to receive the surface acoustic waves that have passed through the gas-sensing layer, and
wherein the gas sensing device further comprises a protective layer on the first IDT electrode and the second IDT electrode.

9. The gas sensing device of claim 7, wherein the micro-heater comprises at least one micro-heater electrode,
wherein the at least one micro-heater electrode is adjacent to one side of the gas-sensing layer, and extends from a region adjacent to the first electrode to a region adjacent to the second electrode, and
wherein the at least one micro-heater electrode comprises a plurality of zigzag patterns.

10. The gas sensing device of claim 1, wherein the gas-sensing layer is free of polymer.

11. The gas sensing device of claim 1, further comprising:
an inlet configured to receive supply of the gas; and
at least one flow path configured to guide the gas from the inlet to the first sensing element,
wherein the at least one flow path comprises a first flow path provided with at least one of a temperature sensor and a humidity sensor, and
wherein the controller is further configured to perform calibration for a change in the resonant frequency caused by at least one of temperature and humidity.

12. The gas sensing device of claim 11, wherein the at least one flow path further comprises a second flow path provided with a dehumidifying filter, a deodorizing filter, or a combination thereof, or a third flow path configured to guide the gas from the inlet to the first sensing element without filtration.

13. The gas sensing device of claim 1, further comprising a second sensing element free of the gas-sensing layer.

14. The gas sensing device of claim 1, wherein the oscillation circuit comprises an amplifier, and
wherein the first sensing element and the amplifier form a feedback loop having a gain of or more.

15. An operating method of a gas sensing device, the operating method comprising:
applying, from an oscillation circuit, a driving voltage to a first sensing element comprising a gas-sensing layer;
inputting, into a counter circuit, a resonant frequency output from the first sensing element; and
determining, by a controller, a weight of adsorbed gas from a change in the resonant frequency corresponding to gas adsorbed to the gas-sensing layer of the first sensing element,
wherein the gas-sensing layer comprises a gas-sensing material, and the gas-sensing material comprises:
a support comprising a three-dimensional metal-organic framework; and
a dual hydrogen bond donor-based receptor bound to the support, and
wherein the three-dimensional metal-organic framework comprises:
a plurality of metal cation nodes; and
an organic ligand between adjacent metal cation nodes of the plurality of metal cation nodes.

16. The operating method of claim 15, wherein the dual hydrogen bond donor-based receptor is represented by Formula 1: 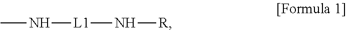
and
wherein —NH-L1-NH— is a dual hydrogen bond donor moiety,
L1 is a thiocarbonyl group or a cycloalkenone group, and
R is an aromatic group having 6 to 20 carbon atoms, substituted with an electron-withdrawing group.

17. The operating method of claim 15, further comprising regenerating the gas-sensing layer by heating the first sensing element.

18. A gas-sensing material comprising:
a support comprising a three-dimensional metal-organic framework; and
a dual hydrogen bond donor-based receptor bound to the support,
wherein the three-dimensional metal-organic framework comprises:
a plurality of metal cation nodes; and
an organic ligand between adjacent metal cation nodes of the plurality of metal cation nodes,
wherein the dual hydrogen bond donor-based receptor is represented by Formula 1: 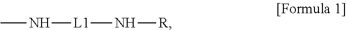
and
wherein —NH-L1-NH— is a dual hydrogen bond donor moiety,
L1 is a thiocarbonyl group or a cycloalkenone group, and
R is an aromatic group having 6 to 20 carbon atoms, substituted with an electron-withdrawing group.

19. The gas-sensing material of claim 18, wherein the dual hydrogen bond donor-based receptor is represented by Formula 2: 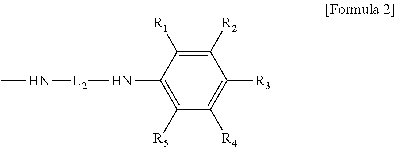
wherein L₂ is a thiocarbonyl group, a cyclobutenedione group, or a cyclopentenetrione group,
R₁, R₂, R₃, R₄, and R₅ are each independently a halogen, a halogen-substituted or unsubstituted C1 to C10 alkyl group, a halogen-substituted or unsubstituted C2 to C10 alkenyl group, and a halogen-substituted or unsubstituted C6 to C20 aryl group, and
at least one of R₁, R₂, R₃, R₄, or R₅ comprises a halogen.

20. The gas-sensing material of claim 18, wherein the dual hydrogen bond donor-based receptor is represented by one of Formulas 3A, 3B, and 3C: 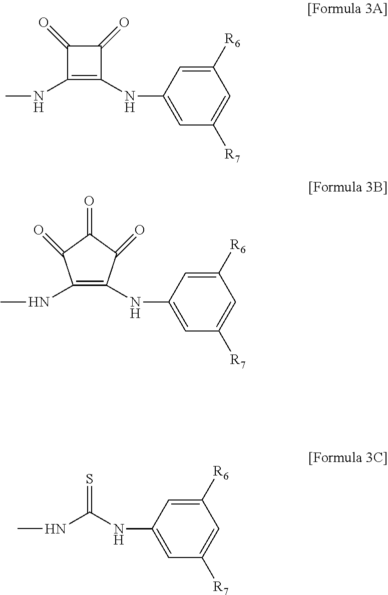
wherein R₆ and R₇ are each independently a halogen, a halogen-substituted or unsubstituted C1 to C5 alkyl group, a halogen-substituted or unsubstituted C2 to C5 alkenyl group, and a halogen-substituted or unsubstituted C6 to C20 aryl group, and
at least one of R₆ and R₇ comprises a halogen.
